(19) United States
(12) Patent Application Publication
(10) Pub. No.: US 2025/0247808 A1
(43) Pub. Date: Jul. 31, 2025

(54) APPARATUS, METHOD AND COMPUTER PROGRAM

(71) Applicant: Nokia Technologies Oy, Espoo (FI)

(72) Inventors: Subramanya CHANDRASHEKAR, Bangalore (IN); Laurent THIÉBAUT, Munich (DE); Ömer BULAKCI, Munich (DE); Hannu FLINCK, Espoo (FI); Christian MANNWEILER, Munich (DE)

(21) Appl. No.: 18/705,266

(22) PCT Filed: Oct. 28, 2021
(86) PCT No.: PCT/IB2021/060000

§ 371 Date: Apr. 26, 2024

(51) Int. Cl. H04W 60/04; H04W 48/20; H04W 76/20; H04W 76/30

(52) U.S. Cl. CPC H04W 60/04; H04W 48/20; H04W 76/20; H04W 76/30

(57) ABSTRACT

An apparatus comprising means for performing: receiving a registration or service request for a user equipment: creating an association between the apparatus and a network function, wherein the association is specific to the user equipment: forwarding the registration or service request to the network function: using the association to receive from the network function or send to the network function at least one of: Non Access Stratum control messages for the user equipment: Access Network control messages for the user equipment.

### FIELD

This disclosure relates to wireless communications and wireless communications systems. Some examples relate to a decentralized network function.

### BACKGROUND

In some wireless networks, for example in 5G Core (5GC) network of a wireless network, Access and Mobility Management Function (AMF) and Session Management Functions (SMFs) are hosted in the Core Network (CN).

### STATEMENT OF INVENTION

According to a first aspect there is provided an apparatus comprising means for performing: receiving a registration or service request for a user equipment; creating an association between the apparatus and a network function, wherein the association is specific to the user equipment; forwarding the registration or service request to the network function; using the association to receive from the network function or send to the network function at least one of: Non Access Stratum control messages for the user equipment; Access Network control messages for the user equipment.

According to some examples, creating the association comprises: establishing an interface for communication between the apparatus and the network function for at least one of: Non Access Stratum control messages for the user equipment; Access Network control messages for the user equipment.

According to some examples, the means are further configured to perform: generating association information corresponding to the association; forwarding the association information to the network function.

According to some examples, the apparatus is deployed locally to a radio access network node.

According to some examples, the apparatus is co-located with an intermediate SMF, i-SMF, and a gNB-Central Unit Control Plane, gNB CU-CP.

According to some examples, the co-location of the i-SMF, gNB CU-CP and the apparatus forms a unified control plane entity.

According to some examples, the unified control plane entity may comprise interfaces between any of the i-SMF, gNB CU-CP and the apparatus that are not externally visible outside of the unified control plane entity.

According to some examples, the means are further configured to perform: releasing the association specific to the user equipment between the apparatus and the network function upon triggering a release request from the apparatus or upon receiving a release request from the network function.

According to some examples, the registration or service request from the user equipment comprises: a Globally Unique Temporary Identifier; or no Globally Unique Temporary Identifier and a Subscription Concealed Identifier, and the means are further configured to perform: receiving a registration acceptance message and in response: assigning a Globally Unique Temporary Identifier to the user equipment.

According to some examples, the means are further configured to perform: forwarding at least one of N1 signalling and N2 signalling received from the user equipment to the network function; receiving at least one of N1 signalling and N2 signalling from the network function and forwarding the N1 signalling and N2 signalling to the user equipment.

According to some examples, the means are further configured to perform: subscribing to the network function for information of changes to Security material for the user equipment; receiving, from the network function, security material for the user equipment; using the security material to terminate Non Access Stratum signalling at the apparatus.

According to some examples, the means are further configured to perform: receiving a request from the network function to handle a Protocol Data Unit, PDU, session for the user equipment, the request comprising at least one of a PDU session identifier, a network slice identifier, a network slice group identifier, a Non Access Stratum Request from the user equipment and identification of a Session Management Function selected for the PDU session by the network function; in response to the request, managing the PDU session for the user equipment.

According to some examples, managing the PDU session for the user equipment includes at least one of: handling of NAS exchanges with the user equipment about the PDU Session, handling the User plane activation and deactivation for the PDU Session; handling mobility aspects of the PDU session.

According to some examples, the Session Management Function may comprise an i-SMF co-located with the apparatus.

According to some examples, the apparatus comprises a L-AMF.

According to some examples, the network function comprises a C-AMF.

According to a second aspect there is provided an apparatus comprising: at least one processor; and at least one memory including computer program code; the at least one memory and the computer program code configured to, with the at least one processor, cause the apparatus at least to perform: receiving a registration or service request for a user equipment; creating an association between the apparatus and a network function, wherein the association is specific to the user equipment; forwarding the registration or service request to the network function; using the association to receive from the network function or send to the network function at least one of: Non Access Stratum control messages for the user equipment; Access Network control messages for the user equipment.

According to some examples, creating the association comprises: establishing an interface for communication between the apparatus and the network function for at least one of: Non Access Stratum control messages for the user equipment; Access Network control messages for the user equipment.

According to some examples, the at least one memory and the computer program code are configured to, with the at least one processor, cause the apparatus at least to perform: generating association information corresponding to the association; forwarding the association information to the network function.

According to some examples, the apparatus is deployed locally to a radio access network node.

According to some examples, the apparatus is co-located with an intermediate SMF, i-SMF, and a gNB-Central Unit Control Plane, gNB CU-CP.

According to some examples, the co-location of the i-SMF, gNB CU-CP and the apparatus forms a unified control plane entity.

According to some examples, the unified control plane entity may comprise interfaces between any of the i-SMF, gNB CU-CP and the apparatus that are not externally visible outside of the unified control plane entity.

According to some examples, the at least one memory and the computer program code are configured to, with the at least one processor, cause the apparatus at least to perform: releasing the association specific to the user equipment between the apparatus and the network function upon triggering a release request from the apparatus or upon receiving a release request from the network function.

According to some examples, the registration or service request from the user equipment comprises: a Globally Unique Temporary Identifier; or no Globally Unique Temporary Identifier and a Subscription Concealed Identifier, and the at least one memory and the computer program code configured to, with the at least one processor, cause the apparatus at least to perform: receiving a registration acceptance message and in response: assigning a Globally Unique Temporary Identifier to the user equipment.

According to some examples, the at least one memory and the computer program code are configured to, with the at least one processor, cause the apparatus at least to perform: forwarding at least one of N1 signalling and N2 signalling received from the user equipment to the network function; receiving at least one of N1 signalling and N2 signalling from the network function and forwarding the N1 signalling and N2 signalling to the user equipment.

According to some examples, the at least one memory and the computer program code are configured to, with the at least one processor, cause the apparatus at least to perform: subscribing to the network function for information of changes to Security material for the user equipment; receiving, from the network function, security material for the user equipment; using the security material to terminate Non Access Stratum signalling at the apparatus.

According to some examples, the at least one memory and the computer program code are configured to, with the at least one processor, cause the apparatus at least to perform: receiving a request from the network function to handle a Protocol Data Unit, PDU, session for the user equipment, the request comprising at least one of a PDU session identifier, a network slice identifier, a network slice group identifier, a Non Access Stratum Request from the user equipment and identification of a Session Management Function selected for the PDU session by the network function; in response to the request, managing the PDU session for the user equipment.

According to some examples, managing the PDU session for the user equipment includes at least one of: handling of NAS exchanges with the user equipment about the PDU Session, handling the User plane activation and deactivation for the PDU Session; handling mobility aspects of the PDU session.

According to some examples, the Session Management Function may comprise an i-SMF co-located with the apparatus.

According to some examples, the apparatus comprises a L-AMF.

According to some examples, the network function comprises a C-AMF

According to a third aspect there is provided an apparatus comprising: circuitry for: receiving a registration or service request for a user equipment; creating an association between the apparatus and a network function, wherein the association is specific to the user equipment; forwarding the registration or service request to the network function; using the association to receive from the network function or send to the network function at least one of: Non Access Stratum control messages for the user equipment; Access Network control messages for the user equipment.

According to a fourth aspect there is provided a method comprising: receiving a registration or service request for a user equipment; creating an association between an apparatus and a network function, wherein the association is specific to the user equipment; forwarding the registration or service request to the network function; using the association to receive from the network function or send to the network function at least one of: Non Access Stratum control messages for the user equipment; Access Network control messages for the user equipment.

According to some examples, the method is performed by the apparatus.

According to some examples, creating the association comprises: establishing an interface for communication between the apparatus and the network function for at least one of: Non Access Stratum control messages for the user equipment; Access Network control messages for the user equipment.

According to some examples, the method comprises: generating association information corresponding to the association; forwarding the association information to the network function.

According to some examples, the method is performed by an apparatus deployed locally to a radio access network node.

According to some examples, method is performed by an apparatus co-located with an intermediate SMF, i-SMF, and a gNB-Central Unit Control Plane, gNB CU-CP.

According to some examples, the co-location of the i-SMF, gNB CU-CP and the apparatus forms a unified control plane entity.

According to some examples, the unified control plane entity may comprise interfaces between any of the i-SMF, gNB CU-CP and the apparatus that are not externally visible outside of the unified control plane entity.

According to some examples, the method comprises: releasing the association specific to the user equipment between the apparatus and the network function upon triggering a release request from the apparatus or upon receiving a release request from the network function.

According to some examples, the registration or service request from the user equipment comprises: a Globally Unique Temporary Identifier; or no Globally Unique Temporary Identifier and a Subscription Concealed Identifier, and the method comprises: receiving a registration acceptance message and in response: assigning a Globally Unique Temporary Identifier to the user equipment.

According to some examples, the method comprises: forwarding at least one of N1 signalling and N2 signalling received from the user equipment to the network function; receiving at least one of N1 signalling and N2 signalling from the network function and forwarding the N1 signalling and N2 signalling to the user equipment.

According to some examples, the method comprises: subscribing to the network function for information of changes to Security material for the user equipment; receiving, from the network function, security material for the user equipment; using the security material to terminate Non Access Stratum signalling at the apparatus.

According to some examples, the method comprises: receiving a request from the network function to handle a Protocol Data Unit, PDU, session for the user equipment, the request comprising at least one of a PDU session identifier, a network slice identifier, a network slice group identifier, a Non Access Stratum Request from the user equipment and identification of a Session Management Function selected for the PDU session by the network function; in response to the request, managing the PDU session for the user equipment.

According to some examples, managing the PDU session for the user equipment includes at least one of: handling of NAS exchanges with the user equipment about the PDU Session, handling the User plane activation and deactivation for the PDU Session; handling mobility aspects of the PDU session.

According to some examples, the Session Management Function may comprise an i-SMF co-located with the apparatus.

According to some examples, the apparatus comprises a L-AMF.

According to some examples, the network function comprises a C-AMF

According to a fifth aspect there is provided a computer program comprising instructions for causing an apparatus to perform at least the following: receiving a registration or service request for a user equipment; creating an association between the apparatus and a network function, wherein the association is specific to the user equipment; forwarding the registration or service request to the network function; using the association to receive from the network function or send to the network function at least one of: Non Access Stratum control messages for the user equipment; Access Network control messages for the user equipment.

According to a sixth aspect there is provided a computer program comprising instructions stored thereon for performing at least the following: receiving a registration or service request for a user equipment; creating an association between an apparatus and a network function, wherein the association is specific to the user equipment; forwarding the registration or service request to the network function; using the association to receive from the network function or send to the network function at least one of: Non Access Stratum control messages for the user equipment; Access Network control messages for the user equipment.

According to a seventh aspect there is provided a non-transitory computer readable medium comprising program instructions for causing an apparatus to perform at least the following: receiving a registration or service request for a user equipment; creating an association between the apparatus and a network function, wherein the association is specific to the user equipment; forwarding the registration or service request to the network function; using the association to receive from the network function or send to the network function at least one of: Non Access Stratum control messages for the user equipment; Access Network control messages for the user equipment.

According to an eighth aspect there is provided a non-transitory computer readable medium comprising program instructions stored thereon for performing at least the following: receiving a registration or service request for a user equipment; creating an association between an apparatus and a network function, wherein the association is specific to the user equipment; forwarding the registration or service request to the network function; using the association to receive from the network function or send to the network function at least one of: Non Access Stratum control messages for the user equipment; Access Network control messages for the user equipment.

According to a ninth aspect there is provided an apparatus comprising means for performing: receiving association information for an association between the apparatus and a network function. wherein the association is specific to a user equipment; receiving, from the network function, a registration or service request for the user equipment; using the association information to receive from the network function or send to the network function at least one of: Non Access Stratum control messages for the user equipment; Access Network control messages for the user equipment.

According to some examples, the association is created by the network function establishing an interface for communication between the apparatus and the network function for at least one of: Non Access Stratum control messages for the user equipment; Access Network control messages for the user equipment.

According to some examples, the network function is co-located with an intermediate SMF, i-SMF, and a gNB-Central Unit Control Plane, gNB CU-CP.

According to some examples, the co-location of the i-SMF, gNB CU-CP and the apparatus forms a unified control plane entity.

According to some examples, the unified control plane entity may comprise no interfaces between any of the i-SMF. gNB CU-CP and the apparatus that are externally visible.

According to some examples, the means are further configured to perform: releasing the association information specific to the user equipment between the apparatus and the network function upon triggering a release request from the apparatus or upon receiving a release request from the network function.

According to some examples, the means are further configured to perform: prior to using the association information to receive from the network function or send to the network function at least one of: Non Access Stratum control messages for the user equipment; Access Network control messages for the user equipment: ensuring the apparatus has a proper security context for the user equipment.

According to some examples, the means are further configured to perform: receiving at least one of N1 signalling and N2 signalling from the network function; sending at least one of N1 signalling and N2 signalling to the user equipment via the network function.

According to some examples, the means are further configured to perform: receiving a subscription request from the network function for information of changes to Security material for the user equipment; sending, to the network function, security material for the user equipment.

According to some examples, the means are further configured to perform: sending a request to a Session Management Function to handle a PDU, session for the user equipment, the request comprising at least one of: a PDU session identifier, a network slice identifier, a network slice group identifier; a Non Access Stratum Request from the user equipment; sending, to the network function, a request for the network function to interface the Session Management Function for this PDU Session.

According to some examples, the means are further configured to perform: sending a request to the network function to manage a PDU session for the user equipment, the request comprising a PDU session identifier, a network slice identifier, a network slice group identifier; a Non Access Stratum Request from the user equipment and identification of a Session Management Function selected for the PDU session; wherein the request comprises an implicit indication for the network function to select a co-located intermediate Session Management Function for handling the PDU session.

According to some examples, the apparatus is configured to communicate with a 5GC network such that the network entity can communicate with the 5GC network via the apparatus.

According to some examples, the means are further configured to perform: receiving a further request related to mobility of the user equipment; selecting a new network function for a target RAN node for the user equipment; creating an association between the apparatus and the new network function for the user equipment; forwarding the mobility request to the network function; using the association to receive from the new network function or send to the new network function at least one of: Non Access Stratum control messages for the user equipment; Access Network control messages for the user equipment.

According to some examples, the Session Management Function may comprise an i-SMF co-located with the network function.

According to some examples, the apparatus comprises a C-AMF.

According to some examples, the network function comprises a L-AMF.

According to a tenth aspect there is provided an apparatus comprising: at least one processor; and at least one memory including computer program code; the at least one memory and the computer program code configured to, with the at least one processor, cause the apparatus at least to perform: receiving association information for an association between the apparatus and a network function, wherein the association is specific to a user equipment; receiving, from the network function, a registration or service request for the user equipment; using the association information to receive from the network function or send to the network function at least one of: Non Access Stratum control messages for the user equipment; Access Network control messages for the user equipment.

According to some examples, the association is created by the network function establishing an interface for communication between the apparatus and the network function for at least one of: Non Access Stratum control messages for the user equipment; Access Network control messages for the user equipment.

According to some examples, the network function is co-located with an intermediate SMF, i-SMF, and a gNB-Central Unit Control Plane, gNB CU-CP.

According to some examples, the co-location of the i-SMF, gNB CU-CP and the apparatus forms a unified control plane entity.

According to some examples, the unified control plane entity may comprise no interfaces between any of the i-SMF, gNB CU-CP and the apparatus that are externally visible.

According to some examples, the at least one memory and the computer program code are configured to, with the at least one processor, cause the apparatus at least to perform: releasing the association information specific to the user equipment between the apparatus and the network function upon triggering a release request from the apparatus or upon receiving a release request from the network function.

According to some examples, the at least one memory and the computer program code are configured to, with the at least one processor, cause the apparatus at least to perform: prior to using the association information to receive from the network function or send to the network function at least one of: Non Access Stratum control messages for the user equipment; Access Network control messages for the user equipment: ensuring the apparatus has a proper security context for the user equipment.

According to some examples, the at least one memory and the computer program code are configured to, with the at least one processor, cause the apparatus at least to perform: receiving at least one of N1 signalling and N2 signalling from the network function; sending at least one of N1 signalling and N2 signalling to the user equipment via the network function.

According to some examples, the at least one memory and the computer program code are configured to, with the at least one processor, cause the apparatus at least to perform: receiving a subscription request from the network function for information of changes to Security material for the user equipment; sending, to the network function, security material for the user equipment.

According to some examples, the at least one memory and the computer program code are configured to, with the at least one processor, cause the apparatus at least to perform: sending a request to a Session Management Function to handle a PDU, session for the user equipment, the request comprising at least one of: a PDU session identifier, a network slice identifier, a network slice group identifier; a Non Access Stratum Request from the user equipment; sending, to the network function, a request for the network function to interface the Session Management Function for this PDU Session.

According to some examples, the at least one memory and the computer program code are configured to, with the at least one processor, cause the apparatus at least to perform: sending a request to the network function to manage a PDU session for the user equipment, the request comprising a PDU session identifier, a network slice identifier, a network slice group identifier; a Non Access Stratum Request from the user equipment and identification of a Session Management Function selected for the PDU session; wherein the request comprises an implicit indication for the network function to select a co-located intermediate Session Management Function for handling the PDU session.

According to some examples, the apparatus is configured to communicate with a 5GC network such that the network entity can communicate with the 5GC network via the apparatus.

According to some examples, the at least one memory and the computer program code are configured to, with the at least one processor, cause the apparatus at least to perform: receiving a further request related to mobility of the user equipment; selecting a new network function for a target RAN node for the user equipment; creating an association between the apparatus and the new network function for the user equipment; forwarding the mobility request to the network function; using the association to receive from the new network function or send to the new network function at least one of: Non Access Stratum control messages for the user equipment; Access Network control messages for the user equipment.

According to some examples, the Session Management Function may comprise an i-SMF co-located with the network function.

According to some examples, the apparatus comprises a C-AMF. According to some examples, the network function comprises a L-AMF

According to an eleventh aspect there is provided an apparatus comprising: circuitry for:

receiving association information for an association between the apparatus and a network function, wherein the association is specific to a user equipment; receiving, from the network function, a registration or service request for the user equipment; using the association information to receive from the network function or send to the network function at least one of: Non Access Stratum control messages for the user equipment; Access Network control messages for the user equipment.

According to a twelfth aspect there is provided a method comprising: receiving association information for an association between an apparatus and a network function, wherein the association is specific to a user equipment; receiving, from the network function, a registration or service request for the user equipment; using the association information to receive from the network function or send to the network function at least one of: Non Access Stratum control messages for the user equipment; Access Network control messages for the user equipment.

According to some examples the method is performed by the apparatus.

According to some examples, the association is created by the network function establishing an interface for communication between the apparatus and the network function for at least one of: Non Access Stratum control messages for the user equipment; Access Network control messages for the user equipment.

According to some examples, the network function is co-located with an intermediate SMF, i-SMF, and a gNB-Central Unit Control Plane, gNB CU-CP.

According to some examples, the co-location of the i-SMF, gNB CU-CP and the apparatus forms a unified control plane entity.

According to some examples, the unified control plane entity may comprise no interfaces between any of the i-SMF. gNB CU-CP and the apparatus that are externally visible.

According to some examples, the method comprises: releasing the association information specific to the user equipment between the apparatus and the network function upon triggering a release request from the apparatus or upon receiving a release request from the network function.

According to some examples, the method comprises: prior to using the association information to receive from the network function or send to the network function at least one of: Non Access Stratum control messages for the user equipment; Access Network control messages for the user equipment: ensuring the apparatus has a proper security context for the user equipment.

According to some examples, the method comprises: receiving at least one of N1 signalling and N2 signalling from the network function; sending at least one of N1 signalling and N2 signalling to the user equipment via the network function.

According to some examples, the method comprises: receiving a subscription request from the network function for information of changes to Security material for the user equipment; sending, to the network function, security material for the user equipment.

According to some examples, the method comprises: sending a request to a Session Management Function to handle a PDU, session for the user equipment, the request comprising at least one of: a PDU session identifier, a network slice identifier, a network slice group identifier; a Non Access Stratum Request from the user equipment; sending, to the network function, a request for the network function to interface the Session Management Function for this PDU Session.

According to some examples, the method comprises: sending a request to the network function to manage a PDU session for the user equipment, the request comprising a PDU session identifier, a network slice identifier, a network slice group identifier; a Non Access Stratum Request from the user equipment and identification of a Session Management Function selected for the PDU session; wherein the request comprises an implicit indication for the network function to select a co-located intermediate Session Management Function for handling the PDU session.

According to some examples, the method is performed by an apparatus configured to communicate with a 5GC network such that the network entity can communicate with the 5GC network via the apparatus.

According to some examples, the method comprises: receiving a further request related to mobility of the user equipment; selecting a new network function for a target RAN node for the user equipment; creating an association between the apparatus and the new network function for the user equipment; forwarding the mobility request to the network function; using the association to receive from the new network function or send to the new network function at least one of: Non Access Stratum control messages for the user equipment; Access Network control messages for the user equipment.

According to some examples, the Session Management Function may comprise an i-SMF co-located with the network function.

According to some examples, the method is performed by a C-AMF.

According to some examples, the network function comprises a L-AMF.

According to a thirteenth aspect there is provided a computer program comprising instructions for causing an apparatus to perform at least the following: receiving association information for an association between the apparatus and a network function, wherein the association is specific to a user equipment; receiving, from the network function, a registration or service request for the user equipment; using the association information to receive from the network function or send to the network function at least one of: Non Access Stratum control messages for the user equipment; Access Network control messages for the user equipment.

According to a fourteenth aspect there is provided a computer program comprising instructions stored thereon for performing at least the following: receiving association information for an association between an apparatus and a network function, wherein the association is specific to a user equipment; receiving, from the network function, a registration or service request for the user equipment; using the association information to receive from the network function or send to the network function at least one of: Non Access Stratum control messages for the user equipment; Access Network control messages for the user equipment.

According to a fifteenth aspect there is provided a non-transitory computer readable medium comprising program instructions for causing an apparatus to perform at least the following: receiving association information for the association between the apparatus and a network function, wherein the association is specific to a user equipment; receiving, from the network function, a registration or service request for the user equipment; using the association information to receive from the network function or send to the network function at least one of: Non Access Stratum control messages for the user equipment; Access Network control messages for the user equipment.

According to a sixteenth aspect there is provided a non-transitory computer readable medium comprising program instructions stored thereon for performing at least the following: receiving association information for an association between an apparatus and a network function, wherein the association is specific to a user equipment; receiving, from the network function, a registration or service request for the user equipment; using the association information to receive from the network function or send to the network function at least one of: Non Access Stratum control messages for the user equipment; Access Network control messages for the user equipment.

### BRIEF DESCRIPTION OF FIGURES

The invention will now be described in further detail, by way of example only, with reference to the following examples and accompanying drawings, in which:

FIG. 1 shows a schematic representation of part of a network;

FIG. 2 shows a schematic representation of an identifier;

FIG. 3 shows schematic representation of an apparatus according to an example;

FIG. 4 shows a schematic representation of part of a network;

FIG. 5 shows an example message flow;

FIG. 6 shows an example message flow;

FIG. 7 shows an example message flow;

FIG. 8 shows an example of an apparatus;

FIG. 9 shows an example of an apparatus;

FIG. 10 shows an example method flow; and

FIG. 11 shows an example method flow.

### DETAILED DESCRIPTION

The present disclosure relates to wireless communications, e.g., 5G, 5G-Advanced, beyond 5G, and 6G.

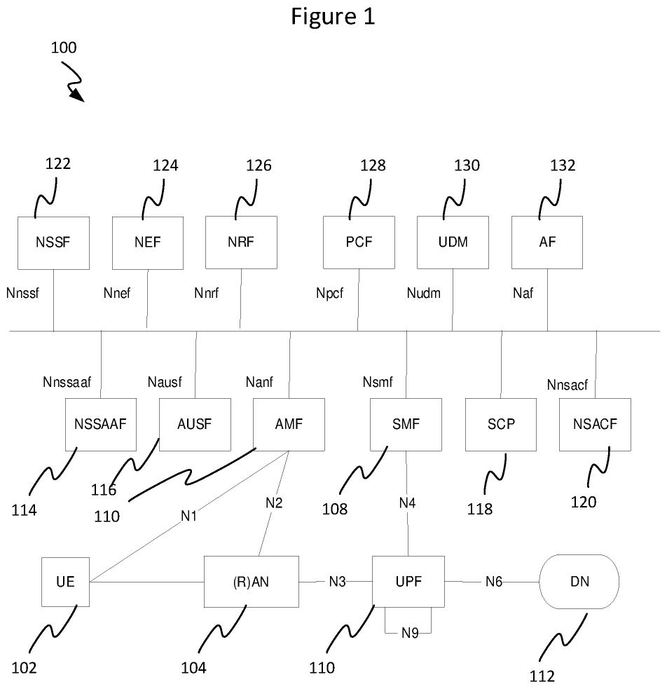

FIG. 1 shows an example of architecture of a network system 100. Network system 100 may, in some examples, comprise the typical architecture of the 5G system (5GS) as described in 3GPP TS 23.501. It will be understood that FIG. 1 shows an example only and there may be more or fewer network entities than depicted.

In FIG. 1, each network entity can be connected to another network entity in the system. In some examples, the connection between one or more of the network entities may comprise an interface, e.g., a service-based interface (SBI).

In the example of FIG. 1, User Equipment (UE) 102 is connected to Access Network (AN) 104. In some examples, AN 104 may comprise a Radio AN (RAN). In the following, AN (104) may also comprise other kinds of Access network entities such as entities terminating non 3GPP access to the 3GPP core (as N3IWF/TNGF in case of 5G Core) or entities terminating wireline access to the 3GPP core (as W-AGF in case of 5G Core).

UE 102 may be connected to AMF 106. In some examples, UE 102 may be connected to AMF 106 by an N1 interface.

In the example of FIG. 1, (R)AN 104 is connected to User Plane Function (UPF) 110. In some examples, (R)AN 104 may be connected to User Plane Function (UPF) 110 by an N3 interface.

In the example of FIG. 1, one UPF 110 is connected to another UPF 110. In some examples, UPF 110 is connected to another UPF 110 by an N9 interface.

In the example of FIG. 1, (R)AN 104 is connected to AMF 106. In some examples, (R)AN 104 is connected to AMF 106 by an N2 interface.

In the example of FIG. 1, UPF 110 is connected to SMF 108. In some examples, UPF 110 is connected to SMF 108 by an N4 interface.

In the example of FIG. 1, Data Network (DN) 112 is connected to UPF 110. In some examples, DN 112 is connected to UPF 110 by an N6 interface.

Network 100 may also comprise one or more of: a Network Slice-Specific Authentication and Authorization Function (NSSAAF) 114, Authentication Server Function (AUSF) 116, Service Communication Proxy (SCP) 118, Network Slice Admission Control Function (NSACF) 120, Network Slice Selection Function (NSSF) 122, Network Exposure Function (NEF) 124, Network Repository Function (NRF) 126, Policy Charging Function (PCF) 128, Unified Data Management (UDM) 130 and Application Function (AF) 132. Each of these network entities may be connected to system 100. In the example of FIG. 1, each entity is connected to system 100 by a respective interface as shown in FIG. 1.

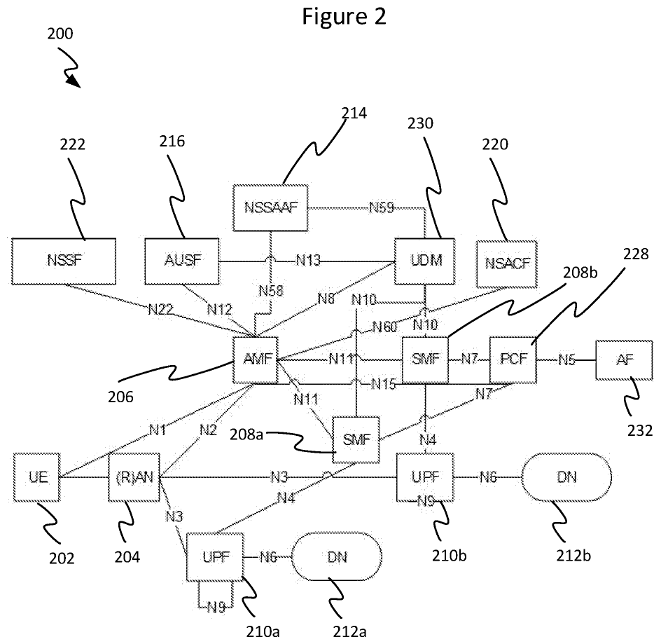

FIG. 2 shows an example of a system 200 where two SMFs are selected for two different Protocol Data Units (PDUs). Each SMF may also have the capability to control both a local and a central UPF within a PDU Session. System 200 comprises UE 202, (R)AN 204, AMF 206, SMF 208a, SMF208b, UPF 210a, UPF 210b, DN 212a, DN 212b, NSSAAF 214, AUSF 216, NSACF 220, NSSF 222, PCF 228, UDM 230 and AF 232. Each network entity may comprise interfaces connecting the respective network entity to system 200 as shown in FIG. 2.

Generally, an AMF is responsible for mobility management and an SMF may perform the session management functions.

According to examples of the invention, an AMF may perform one or more of the following functions:
Terminating the RAN Control Plane (CP) interface (N2);
Non-access Stratum (NAS) signalling (N1);
NAS ciphering and integrity protection of a network;
Mobility Management (MM) layer NAS termination;
Session Management (SM) layer NAS forwarding;
Authenticating one or more UEs in the network;
Managing the security context of the network;
Registration management;
Connection management;
Reachability management;
Selecting a SMF;
Mobility Management;
Apply mobility related policies from PCF.

According to examples of the invention, an SMF may perform one or more of the following functions:
Allocating IP addresses to UEs;
NAS (Non Access Stratum) signalling for session management (SM);
Sending requests for PDU Session resources at Access Network (including e.g. Quality of Service (QOS) information) to Access Network (e.g. RAN) via the AMF;
Downlink data notification;
Selecting and controlling UPF for traffic routing. The UPF selection function may enable Mobile Edge Computing (MEC) by selecting a UPF close to the edge of the network;
Acting as the interface for all communication related to offered user plane services. SMF determines how the policy and charging for these services is applied;
Lawful intercept-control plane.

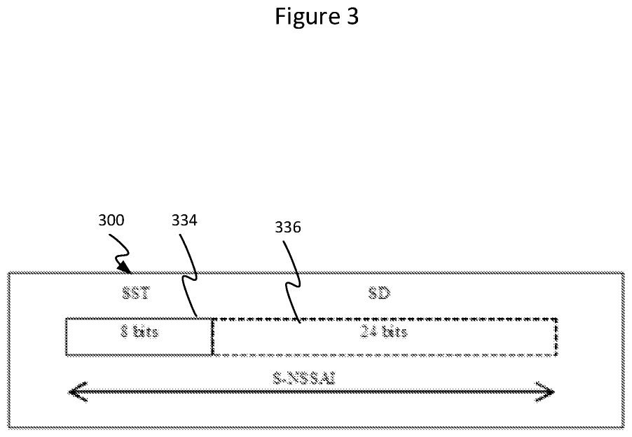

An example identifier 300 that may be used to identify a network slice is shown in FIG. 3. Network slicing is first introduced as a 5G feature to support different services using the same underlying mobile network infrastructure [3GPP TS 38.300]. Network slices can differ either in their service requirements like Ultra-Reliable Low Latency Communication (URLLC) and enhanced Mobile Broadband (eMBB) and/or according to the service-level agreement (SLA) of the tenant that uses those services.

A network slice can be uniquely identified via a S-NSSAI (Single-Network Slice Selection Assistance Information). Current 3GPP specifications allow a UE to be simultaneously connected and served by at most eight slices corresponding to eight S-NSSAIs [3GPP TS 38.300]. On other hand, each cell may support tens or even hundreds of S-NSSAIs, e.g., in the current specifications a tracking area can have a support up to 1024 network slices [3GPP TS 38.423].

Identifier 300 may comprise an S-NSSAI. The S-NSSAI may include a Slice/Service Type (SST) field 334 and a Slice Differentiator (SD) field 336. In some examples, the SST may have an 8-bit length and the SD field may have a 24-bit length so that the total identifier length is 32 bits.

The SST field may have standardized and non-standardized values. In some example, values 0to 127 belong to the standardized SST range. For instance, SST value of 1 may indicate that the slice is suitable for handling of 5G eMBB, 2 for handling of URLLC, etc. In some examples, the SD field 336 is operator-defined only.

In some example situations, for certain services or PDU sessions where the core network-user place (CN-UP) is co-located with the Access Network, e.g., the RAN-user plane (RAN-UP). In such examples, user/application data may terminate in a local network node. As such, there may be no need for the user data to enter the internet or any external network.

An intermediate SMF (I-SMF or i-SMF) has been introduced to support deployment topologies with specific SMF service areas (3GPP TS23.501 Section 5.34). When the UE is outside of an SMF Service Area, an i-SMF (assumed to be deployed ‘locally) is inserted between the SMF (assumed to be deployed ‘centrally’) and the AMF. The i-SMF has an N11 interface with the AMF and an N16a interface with the SMF and is responsible of controlling the ‘local’ UPF(s) that the SMF cannot directly control as well as of dealing with IDLE-CONNECTED transitions and hand-overs when the UE remains in the service area of the I-SMF.

Currently all communications between a 5GC-NF and Access Network, e.g., the RAN go through the AMF (assumed to be deployed more centrally than the Access Network, e.g. the RAN) that is maintaining the UE context. That is, the AMF is the single point of entry for any signalling communication between NG-RAN and 5GC while some signalling should be handled very quickly e.g., in relationship with a Handover (HO) or localization for certain delay-critical services. The former implementation where a possibly fairly central AMF is the single point entry, can be inefficient, from a signalling point-of-view. Despite the i-SMF concept, interaction of the i-SMF with the central AMF can cause signalling inefficiency.

In some examples, an AMF that is split up into two parts is provided. The two parts may comprise a first part comprising a local AMF (L-AMF) deployed with an i-SMF near to an Access Network, e.g., the RAN (which for the RAN may comprise a Central Unit Control Plane (CU-CP) of a gNB) and a second part comprising a central AMF (C-AMF). The L-AMF may comprise an AMF deployed at a site local to an Access Network, e.g., the RAN (or CU-CP for the RAN). In some examples, the L-AMF may be co-located with the CU-CP, and in some cases with co-located with an i-SMF. The co-location of the L-AMF with the CU-CP and optionally additionally with the i-SMF can form a unified network entity in the control plane. This may be considered to be a consolidated (unified) control plane entity. In some examples, a consolidated (unified) control plane entity may comprise interfaces between the different network functions that make up the consolidated (unified) control plane entity that are not externally visible (i.e., cannot be seen from outside the consolidated control plane entity.

“Co-located” apparatuses comprise apparatuses that are situated at the same point in the network. Each of the L-AMF, CU-CP and i-SMF may be considered to be local when they are not a part of the CN. Local apparatuses may be located at or near a RAN. In some examples, the local apparatuses may be deployed in the same cloud, e.g., edge cloud or far-edge cloud. In some examples, apparatuses may be considered local, if they are deployed in a cloud closer to the radio units, e.g., edge cloud and far-edge cloud than other central network functions. The central-AMF may be located at or near the other network functions of the Core (5G-CN or 6G-CN). A central-AMF (C-AMF) may be located closer to the network functions of rest of the Core (5G-CN or 6G-CN) than a L-AMF, which is deployed closer to the radio units than the C-AMF.

In some examples, “co-located” apparatuses may have one or more interfaces between the co-located apparatuses that are not externally visible.

An interface between a C-AMF and L-AMF is introduced to enable (R)AN-Core unification or convergence by bringing selected core network functions closer to (R)AN. For example, lower layer NAS termination, including NAS security as well as full handling of some NAS messages can be brought closer to (R)AN.

The terms core and core network are used interchangeably herein. In the following to simplify the wording it is referred to RAN but it has to be understood that “RAN” refers to any Access Network entity that allows the user equipment (UE) to access to the 3GPP Core (could mean the N3IWF/TNGF/W-AGF accessing the 5G core for example).

In some examples, whether to use an i-SMF co-located with the L-AMF can be determined per PDU session based on criteria such as a selected SMF and/or the PDU session or service characteristics of the PDU session or slice characteristics.

In some examples, by co-locating control plane functionality of RAN and Core for selected PDU sessions, there is reduced signalling and latency. Co-location of at least some control plane functionality RAN and Core can be performed by co-locating, for example, a CU-CP, L-AMF and I-SMF.

The L-AMF may be responsible for Access Network (N2 in case of 5G) termination (3GPP TS 38.413 in case of 5G Core) and for NAS (3GPP TS 24.501 in case of 5G Core) transport termination and can therefore be responsible for NAS security. As there is a single NAS security termination, the 5GS architectural change due to deployment of L-AMF is transparent to UEs of the network, and legacy UEs can be transparently supported. Further, as the RAN interfaces only with L-AMF, the RAN does not need to be modified to accommodate splitting the AMF into two parts. However, further optimizations related to RAN CU-CP colocation with L-AMF and I-SMF may still be made.

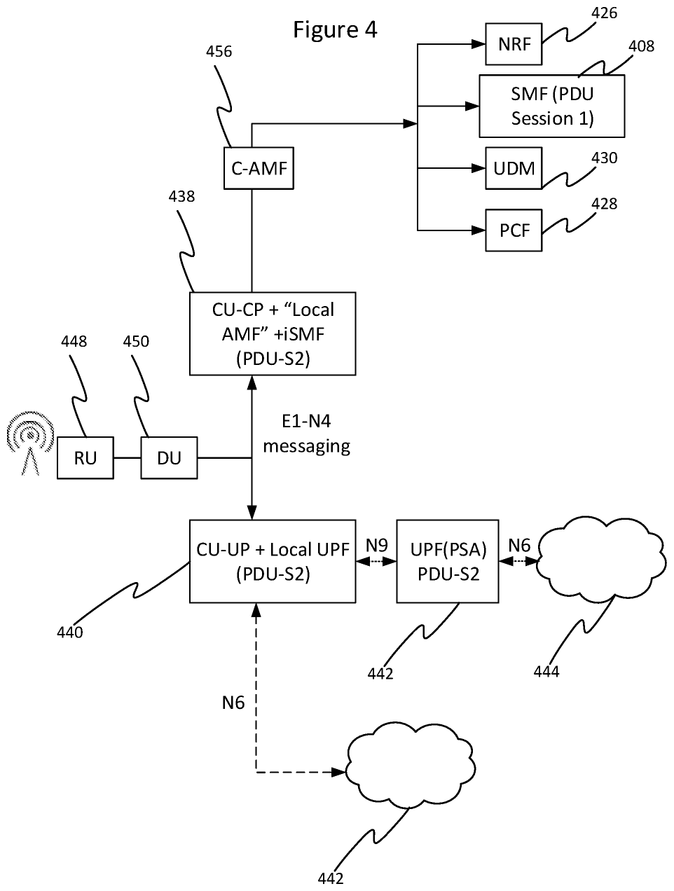

FIG. 4 shows an example of a part of a network comprising an AMF. In some examples the AMF may be service-specific.

In the example of FIG. 4, at 438 a CU-CP. L-AMF and i-SMF are co-located (i.e., at the same network location and/oror having an interface that is not externally visible). The co-located CU-CP, L-AMF and I-SMF can communicate via C-AMF 456 with core functions NRF 426, SMF 408 for a first PDU session 1. UDM 430 and PCF 428. Co-located apparatuses 438 may communicate with a Centralized Unit User Plane (CU-UP) and local UPF 440 for PDU session 2 (PDU-S2). In some examples this communication may occur via E1-N4 messaging. Both co-located apparatuses 438 and CU-UP +local UPF 440 may communicate with DU 450. DU 450 can communicate with Radio Unit (RU) 448.

The profile of the L-AMF may be present in NRF 426. The L-AMF may be registered with NRF 426.

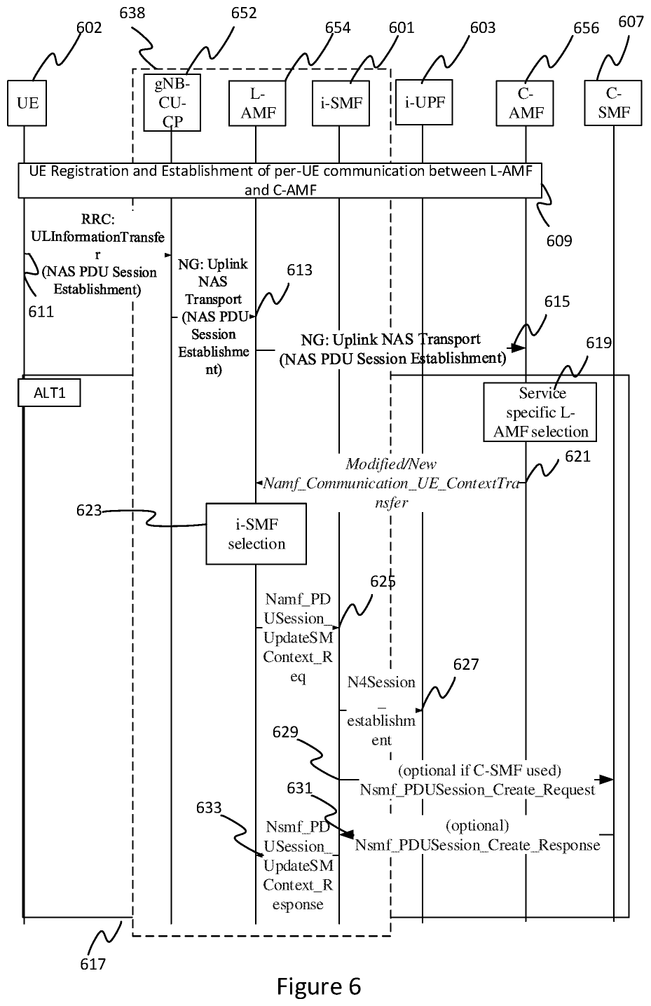

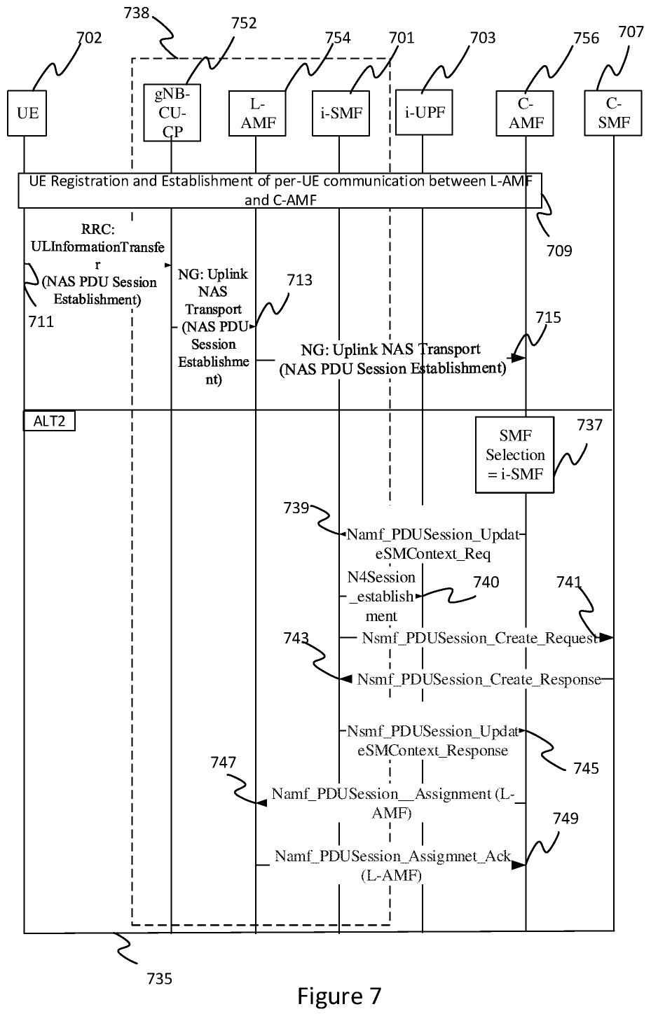

The CU-CP. L-AMF and i-SMF co-location forms a unified control plane entity 438. In some examples, if the L-AMF of control plane entity 438 has the same slice support list as the CU-CP (which in some examples may comprise a gNB-CU-CP), the collocated entity has a single cardinality. In such an example, selection of an L-AMF of control plane entity 438 by a C-AMF for a PDU session implicitly indicates to the L-AMF that the co-located i-SMF should be selected for the PDU session. Such an example is described with respect to FIG. 6 below. In other examples, slice-specific L-AMF instances may be supported. In such cases, a C-AMF can select the slice specific entity (L-AMF) and notify the CU-CP. Such an example is described with respect to FIG. 7 below. The interfaces between CU-CP. L-AMF and i-SMF at 438 may not be externally visible from outside of unified control plane entity 438.

When slice-specific L-AMF instances are supported, a UE may be associated with more than one L-AMF based on slice/service characteristics when required/applicable. Different network slices could be provided based on services. For example, an Enhanced Mobile Broadband (eMBB) service may have a different L-AMF instance compared to an ultra-reliable low latency communication (URLLC) service. As such, a UE may be associated with more than one L-AMF if the UE accesses more than one service/slice or service/slice type. In some examples, an L-AMF will serve only users of authorized slices. Such an example may occur when slices are specific to a certain enterprise-for example slice A may be dedicated to company A and slice B may be dedicated to company B. In some examples, a UE association to an L-AMF can be based on slice group(s). In some examples, a UE association to an L-AMF can be based on slice/service type(s).

In some examples, co-located control plane entity 438 includes interfacing and communication between L-AMF and i-SMF. In such examples, a C-AMF as a transparent forwarder is therefore not required.

In the example of FIG. 4, CU-UP+local UPF 440 may communicate with UPF PDU Session Anchor (PSA) 442 for PDU-S2. In some examples, this communication may be made over an N9 interface. UPF (PSA) 442 may communicate with data network 444. In some examples this communication may be made over an N6 interface.

CU-UP+local UPF 440 may also communicate with data network 446. In some examples, this communication may be over an N6 interface.

In examples, some UPF may be deployed co-located with CU UP locally such as shown at 442. In some examples some UPF may even deployed at DU 450 site. Local UPFs are controlled by the I-SMF of co-located apparatuses 438.

In some examples, C-AMF 456 may hide the existence of L-AMF at 438 to the rest of 5GC (AUSF, UDM, PCF, SMF, NEF, etc.), i.e., the existence of L-AMF at 438 may not be visible to the rest of 5GC (AUSF, UDM, PCF, SMF, NEF, etc.).

In some examples, the existence of L-AMF at 438 may be visible to at least one 5GC function.

In some examples, PDU sessions can optionally be served at the co-located I-SMF located at first location 438. Other PDU sessions may be served by other SMFs in the network, they are not served by the co-located i-SMF.

AN-CN interface is defined as a legacy point to point interface since the very early generations of PLMN. The point to point AN-CN, i.e. for 5G Core, NG-AP protocol (3GPP TS 38.413) between AN and core assumes fixed roles of the communicating peers as well as fixed set of services exhibited across this interface. An interface between L-AMF and C-AMF can be used as a RAN-CN (Radio Access Network-Core Network) interface, replacing the existing NG interface. This implies that some core functionality (e.g.: NAS termination) is now within the RAN. In this case, the RAN can store a common RAN-CN context when an RRC connection is released (includes NAS termination security parameters). Further, considering co-location with I-SMF, the UP control interface allows to command an UP entity that terminates Uu higher layers (Packet Data Convergence Protocol (PDCP), Radio Link Control (RLC)) on one side and GTP-u (GPRS Tunnelling Protocol User plane) towards the Core UPF or even N6 on the other side.

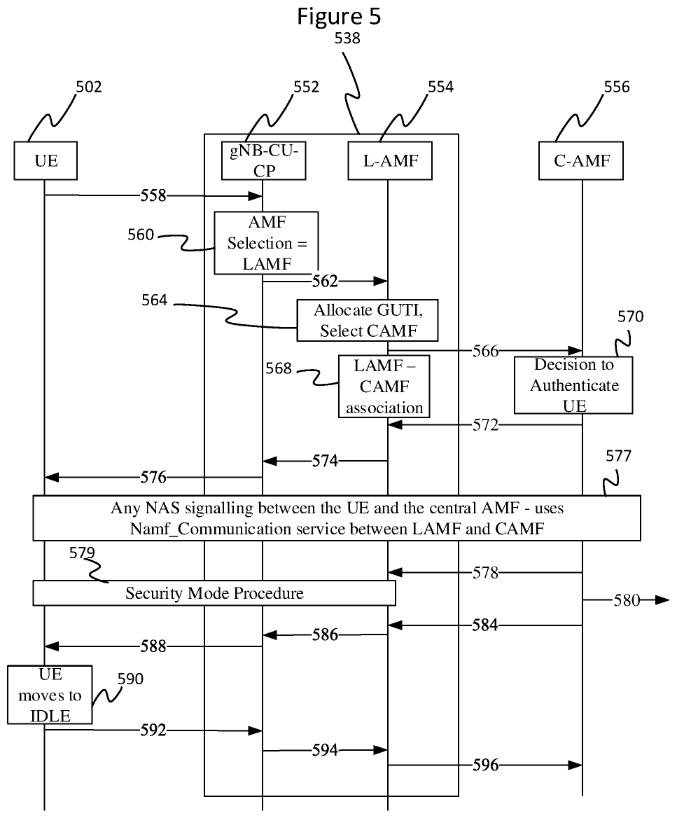

FIG. 5 shows an example message flow in a system comprising an L-AMF 554, C-AMF 556, gNB-CU-CP 552 and UE 502. FIG. 5 shows how a UE can register with an L-AMF, as well as showing establishment of interface between L-AMF and C-AMF and further communication (communication of security information at 578 and 580 and release of a UE context at 590 to 596).

In FIG. 5, the co-location of gNB-CU-CP 552 and L-AMF 554 forms a unified control plane entity 538.

FIG. 5 shows signalling for communication between L-AMF 554 and C-AMF 556. FIG. 5 shows how a RAN including gNB-CU-CP 552 can select an AMF to route an initial NAS message (e.g., a registration message) when the AMF is split into L-AMF 554 and C-AMF 556.

At 558, UE 502 sends a RRC message to gNB-CU-CP 552. The message sent at 558 may comprise a NAS message. The NAS message may be a request to register UE 502 with a network or a Mobility Registration Update message.

At 560, gNB-CU-CP 552 selects an AMF to use for transmission with UE 502. In the example of FIG. 5, gNB-CU-CP 552 selects L-AMF 554.

At 562, gNB-CU-CP 552 sends a message to L-AMF 554. The message may comprise a request to register UE 502 or a mobility registration Update message for UE 502. The message may comprise an Uplink NAS transport message.

At 564, L-AMF 554 allocates an identifier, for example a Globally Unique Temporary Identifier (GUTI) for UE 502. L-AMF 554 also selects C-AMF for UE 502. Although a GUTI can be used, it should be noted that is envisaged that other identifiers may be used, in particular in beyond 5G systems, and that references to “GUTI” throughout the description also include references to such other identifiers.

At 566, L-AMF 554 sends a message to establish an association with C-AMF for an UE (UE context creation). The message may comprise a NAS register message or Mobility Registration Update message to the selected C-AMF 556. In some examples, the message may comprise an Namf_lamf_UEContextCreate message. This request may also be used by L-AMF 554 to subscribe to C-AMF 556 for security information related with the UE (e.g., changes of UE related security keys).

Steps 558, 562 and 566 may comprise routing a NAS registration message from UE 502 to C-AMF 556. In some examples, this may be routed via L-AMF from an NG-RAN node such as L-AMF 554 by default.

At 568, L-AMF 554 associates L-AMF and C-AMF 556.

At 570, C-AMF 556 decides to authenticate UE 502 (assuming that C-AMF does not hold security credentials for the UE or does not get them from another AMF). 570 may occur in parallel, before, or after 568. At 570, C-AMF 556 may ensure it has a proper security context for UE 502, for example by triggering an authentication for the user equipment or reusing a security context it already has about the user equipment

At 572, C-AMF 556 sends a request for downlink information transfer to the UE 502. The message may comprise an N1 message. The request for downlink information transfer may comprise an Namf_Communication (N1) message.

AT 574, L-AMF 554 sends downlink information for UE 502 to gNB-CU-CP 552. The message may comprise a downlink NG NAS transport (N1) message).

At 576, gNB-CU-CP 552 sends confirmation to UE 502 that UE 502 has registered with C-AMF 556. The message sent at 576 may comprise an ULInformation Transfer (N1) message. From the perspective of UE 502, the confirmation may appear as if it was received from a typical AMF rather than from a C-AMF or L-AMF.

At 577, any NAS signalling between UE 502 and C-AMF uses an interface between L-AMF and C-AMF. The interface may comprise a Namf_Communication service.

L-AMF 554 is subscribed to C-AMF 556 for security information (e.g., changes of UE related security keys). At 578, NAS security information is sent from C-AMF 556 to L-AMF 554. In some examples, the NAS security information may e.g. comprise an Namf_lamf_UEContextUpdate message.

At 579 a security mode procedure takes place over L-AMF 554, gNB-CU-CP 552, and UE 502. The NAS security mode at 579 in some examples takes a 5G NAS security context into use, initialises and starts NAS signalling security between UE 502 and L-AMF 554 with the corresponding 5G NAS keys and 5G NAS security algorithms.

At 580, C-AMF 556 sends registration information to the 5GC network, for example to a UDM in the 5GC network. The registration information may comprise an Nudm_UECM_Registration message and an Nudm_SDM_Get message.

At 584, 586 and 588 acceptance of the UE registration may be sent to UE 506. The registration acceptance information is sent over the L-AMF-C-AMF interface to L-AMF 554 at 584. At 586 a registration acceptance message is sent from L-AMF 554 to gNB-CU-CP 552 by an NG: Downlink NAS transport message. At 588 a registration acceptance message is sent from gNB-CU-CP 552 to UE 502 using an RRC message. The message sent at 588 may comprise an RRC: ULInformation Transfer message.

In some examples and as shown at 590, UE 506 may move to an idle state. When this happens, an RRC release message is sent from UE 506 to gNB-CU-CP 552 as shown at 592. A UE context release request is then sent from gNB-CU-CP 552 to L-AMF 554 as shown at 594. This information is then communicated in a message at 596 from L-AMF 554 to C-AMF 556. The message sent at 596 may comprise an NamfEventExposure_Notify message.

In the example of FIG. 5, the NAS registration message sent at 562 rom NG-RAN node 552 is routed to C-AMF 556 via L-AMF 554 by default. This leads to establishment of interface between L-AMF 554 and C-AMF 556. Selection of AMF for PDU sessions is handled by C-AMF. Further signalling is handled by the respective AMF.

FIGS. 6 and 7 show how an AMF is selected for each PDU session after registration of a UE.

In the example of FIGS. 5, 6 and 7, NG-RAN is unaware of the C-AMF/L-AMF split. NG RAN (e.g., gNB-CU-CP 552, 562, 752) selects an AMF that happens to be a L-AMF. As such, the RAN is not required to be modified to use an AMF having an L-AMF/C-AMF split. Selection of SMF for a PDU session is the responsibility of C-AMF. A latency and signalling benefit is provided when a PDU session served by a L-AMF is also served by i-SMF and/or collocated UPF.

In examples, some PDU sessions require an i-SMF and others do not. An i-SMF may be needed when a selected C-SMF cannot control UPF(s) (user plane entities) in the area where the UE is located. All PDU sessions can be controlled by the C-SMF. In examples, the C-AMF receives NAS SM requests for PDU Session establishment and takes decision w.r.t. UE subscription. If it accepts the PDU Session the C-AMF can request the L-AMF to handle a PDU Session, providing the PDU Session ID, associated Slice ID (e.g., S-NSSAI), the NAS request from the UE and the Identification of the SMF selected by the C-AMF. Then it is up to L-AMF to select an I-SMF and to propagate the PDU Session request to the SMF selected by the C-AMF via the I-SMF (local) selected by L-AMF.

In the examples of FIGS. 5, 6 and 7, a control plane or RAN and a control plane of the CN is brought together by co-locating L-AMF, i-SMF and CU-CP and selecting L-AMF and i-SMF for selected PDU sessions. In such examples. The C-AMF remains responsible for SMF selection. When selecting an SMF, C-AMF may use subscription data from a UDM (as obtained at 580 in FIG. 5, for example). Although C-AMF remains responsible for SMF selection in such examples, a C-AMF/L-AMF interface supports functionality where a C-AMF controls the L-AMF to support i-SMF for selected PDU sessions.

In the example of FIG. 6, UE registration and establishment of per-UE communication between L-AMF 654 and C-AMF 656 is established at 609. This may be performed using a similar method as described at 558 to 577 and 580 to 588 above with relation to FIG. 5.

In FIG. 6, the co-location of gNB-CU-CP 652, L-AMF 654 and i-SMF 601 forms a control plane entity 638.

In general and in FIGS. 6 and 7, an L-AMF sends any request for a new PDU Session ID to a C-AMF (this may be done as part of transparent transfer of NAS signalling between the UE and the C-AMF via the L-AMF). If the PDU Session establishment is accepted (with local i-SMF) by C-AMF, C-AMF forwards back the NAS message to the L-AMF+i-SMF with the identity of the selected SMF, requesting that the local AMF+i-SMF establish the PDU Session with the selected SMF. NAS SM signalling can then be exchanged by the SMF via the co-located L-AMF+i-SMF without communicating with a C-AMF (although a C-AMF may optionally be informed in steps 629 and 631 of FIG. 6).

At 611, UE 602 sends a request to gNB-CU-CP 652 to establish a NAS PDU Session. The request may comprise an RRC request. The request may comprise a NAS PDU Session establishment request.

At 613, gNB-CU-CP 652 forwards the request of 611 to L-AMF 613. This may be sent as an NG message or via internal signaling (when the gNB-CU-CP 652 and L-AMF 613 are co-located).

At 615, L-AMF 613 sends the request for a PDU session for UE 602 to C-AMF 656. This may be done as part of transparent transfer of NAS signaling between the UE and the C-AMF via the L-AMF. L-AMF 613 (or L-AMF 713 in FIG. 7) is used to send any request for a new PDU Session ID to C-AMF 656 (C-AMF 756 in FIG. 7).

At 619, if PDU Session establishment is accepted by C-AMF 656, C-AMF 656 can perform a slice or service-specific L-AMF selection. This could occur for example, when a UE is associated with more than one L-AMF as the UE accesses more than one service/slice. In some examples, an L-AMF will serve only users of authorized slices. Such an example may occur when slices are specific to a certain enterprise-for example slice A may be dedicated to company A and slice B may be dedicated to company B. In an example, an Enhanced Mobile Broadband (eMBB) slice/service type may have a different L-AMF instance compared to an ultra-reliable low latency communication (URLLC) slice/service type. In some examples, an L-AMF can be selected according to the slice(s) or slice group(s).

The selection at 619 may be based on at least one of: PDU session identifier; a network slice identifier; a network slice group identifier; a Non Access Stratum Request from the user equipment; and identification of a Session Management Function selected for the PDU session.

At 621, C-AMF 656 requests the selected L-AMF to handle a PDU session. At 621, C-AMF 656 may provide one or more of a PDU Session ID, associated Slice ID (e.g., S-NSSAI), slice group ID, the NAS request from UE 602 and identification of an SMF (such as C-SMF 607) selected by C-AMF 656.

At 623, L-AMF 654 selects i-SMF 601 for the PDU Session. The selection by C-AMF 656 of L-AMF 654 for the PDU session at 619 (indicated to L-AMF 654) may be recognised as an implicit indication by L-AMF 654 to select co-located i-SMF 601 for the PDU session.

L-AMF 654 then propagates the PDU session request to i-SMF 601 at 625. At 627, i-SMF 601 establishes an N4 session with i-UPF 603. At 633, i-SMF 601 responds to L-AMF 654 to update PDU session. UE 602 can then engage in a PDU session using L-AMF 654 and i-SMF 601.

In between 627 and 633, if C-SMF 607 is used, i-SMF 601 issues a PDU session establishment at 629, receiving a response at 631. This provides coordination between i-SMF 601 and C-SMF 607. FIG. 6 sets forth a first alternative for selection of an L-AMF and i-SMF for a PDU session. 619 to 633 carried out in the first alternative are shown in box ALT1 617 of FIG. 6. In this first alternative, the selection of L-AMF 654 by C-AMF 656 implicitly indicates to L-AMF 654 that co-located i-SMF 601 should be selected for the PDU session.

FIG. 7 shows an example of a second alternative for selection of an L-AMF and i-SMF for a PDU session. Steps 709, 711, 713 and 715 are similar to steps 609, 611, 613 and 615 of FIG. 6. However, steps 737 to 749 of ALT2 735 are performed instead of steps 619 to 633 of ALT1 617.

In FIG. 7, the co-location of gNB-CU-CP 752, L-AMF 754 and i-SMF 701 forms a control plane entity 738.

At 737, C-AMF 756 selects i-SMF 701 based on UE location and the slice of the PDU Session. A corresponding message is sent at 739.

At 740, i-SMF 701 establishes an N4 session with i-UPF 703 for the PDU session. Optionally, at 741, a PDU session create Nsmf_PDUSession_Create request is sent from i-SMF 701 to C-SMF 707. Optionally, at 743, a PDU session create Nsmf_PDUSession_Create response is sent from C-SMF 707 to i-SMF 701. 741 and 743 provides coordination between i-SMF 701 and C-SMF 707.

At 745, i-SMF 701 sends a PDU session update to C-AMF 756. C-AMF 756 then assigns the PDU session to L-AMF 754 at 747. The selection of i-SMF 701 is also notified at 747 to L-AMF 754.

In the examples of FIGS. 5, 6 and 7 external entities such as UDM, SMF, PCF etc. are not required to be aware of the intermediate L-AMF. The external entities are required to be aware of the central AMF (C-AMF) only. The central AMF redirects any request from an external NF to the local AMF based on UE ID.

For example, when selecting a L-AMF instance during a UE registration, the C-AMF shall subscribe to event notification from the local AMF, that are required to be reported from the central AMF towards an external entity.

When a local AMF receives a notification of an event it will send that to the central AMF which then sends it to the original event subscriber. In other words, the C-AMF is responsible for relaying the notifications from the local AMF towards external entities.

In the examples of FIGS. 6 and 7, after a PDU session is set up for UE 602/702, C-AMF 656/756 can request to release the PDU session based on a trigger from a 5GC entity. Such a trigger may comprise, for example, an update from a UDM, an indication of a subscription cancellation, etc. As such, a single UE (e.g., UE 602 or UE 702) having two different PDU sessions could be served by a C-AMF (e.g., C-AMF 656/756) for a first session and by an L-AMF 654/754) for a second session.

Elements of the L-AMF/C-AMF interface are discussed below with respect to FIGS. 4, 5 and 6.

In some examples, an interface between L-AMF and C-AMF is created by taking into account existing AMF services where one of C-AMF and of L-AMF is using AMF services produced by its corresponding peer AMF entity (one of L-AMF and of C-AMF), demanding co-ordination between C-AMF and L-AMF. This is to relay NAS and 5G AN control messages.

When an L-AMF deals with a new UE connection (for example, the UE is related to an unknown Global Unique Temporary Identifier (GUTI) or has no GUTI but has a Subscription Concealed Identifier (SUCI)), a L-AMF-C-AMF relationship is created for the new UE. Such an example is shown at 558 to 568 of FIG. 5, particularly at 566 where a message informing of the new UE is sent from L-AMF 554 to C-AMF 556 and the L-AMF-C-AMF association is made at 568. The message sent at 556 may comprise, for example, a Registration request or a Service Request for UE 502. The association may, in some examples, be specific to UE 502. In some examples, creating the association may comprise establishing an interface for communication between the apparatus and the network function for at least one of: Non Access Stratum control messages for the user equipment; Access Network control messages for the user equipment. When the association has been created, information describing the association may optionally be forwarded to C-AMF 556. Creating an association at 568 may be performed before or after forwarding the request at 566. L-AMF 554 may also generate association information that can be sent to C-AMF 556 to inform C-AMF 556 of the created association. The association information may describe an interface between C-AMF and L-AMF for example.

When a C-AMF or L-AMF requests that a relationship for a UE is released, the relationship may be released. The L-AMF-C-AMF association made at 558 may therefore be released upon request of either L-AMF 554 or C-AMF 556.

In examples, relay of N2 and/or N1 signalling is made between L-AMF and C-AMF. The L-AMF forwards to C-AMF N2 and/or N1 signalling received from UE 502 that cannot entirely be handled by L-AMF 554. This can use Namf_Communication_N1N2MessageSubscribe, Namf_Communication_N1MessageNotify, Namf_Communication_N2InfoNotify). An example of relay of N2 and/or N1 signalling is made between L-AMF 554 and C-AMF 556 can be seen at 566 and 596 of FIG. 5, for example.

In the system of any of FIGS. 4 to 7, the C-AMF forwards to L-AMF N2 and/or N1 signalling to be sent to the UE via the AN. Namf_Communication service may be used for this purpose. Examples of such forwarding can be seen, for example, at 572, 578 and 584.

When a new UE connection is made (e.g., at 55 to 562), the L-AMF is responsible for allocating the GUTI to the UE (as seen at 564). This includes, at the latest, upon reception of a NAS registration accept message to be sent to the UE, the L-AMF allocates a GUTI to the UE.

L-AMF may also re-allocate a GUTI when the GUTI or M-Temporary Mobile Subscriber Identity (M-TMSI) has been used on the radio interface. The radio interface is between the UE and CU-CP (for example, between UE 502 and gNB-CU-CP 552, UE602 and gNB-CU-CP 652, UE 702 and gNB-CU-CP 752.

In some examples, the C-AMF provides NAS security material for the L-AMF to be able to terminate NAS signalling. In such examples, the C-AMF configures the L-AMF with NAS security keys (for example by modifying the L-AMF-C-AMF relationship for a UE). This can be seen, for example, at 578. The L-AMF subscribes onto C-AMF about changes of NAS security keys. The C-AMF can provide and update the NAS baseline keys. In some examples, the L-AMF may receive a seed key out of which it derives both NAS and AS (Access Network) security material.

Once a UE is registered and a communication between L-AMF and C-AMF has been established (as shown in FIGS. 5, 609 and 709), a C-AMF can request an L-AMF to handle a PDU session. This can be seen in 617 and 735. In the request, the C-AMF can provide the PDU Session ID, associated Slice ID (e.g., S-NSSAI), the NAS request from the UE and the Identification of the SMF/UPF selected by the C-AMF (e.g.: I-SMF for eligible PDU sessions). Once it has received such request, the L-AMF acts as the AMF handling all events related with the PDU Session

In some examples, the C-AMF can subscribe to L-AMF for Connection Management events (for example, connection management events as defined in 3GPP TS 23.502 Section 5.2.2.3 Namf_EventExposure service.

When a Service Request (SR) is received by an L-AMF, L-AMF handles the PDU Session(s) it is responsible for, using the relationship with the i-SMF. The service request may be sent by a UE to an L-AMF via a CU-CP. If there are other PDU sessions, the L-AMF forwards the NAS SR message to the C-AMF (for example using Namf_Communication_N1MessageNotify, Namf_Communication_N2InfoNotify).

When a Path Switch Request (PSR) is received from RAN, the L-AMF can notify the i-SMF for the session responsible and forwards the PSR to C-AMF forwards the NAS SR (in some examples, this forwarding uses Namf_Communication_N2InfoNotify).

When a Handover Request or mobility request is received (sent from target AMF to target RAN) C-AMF selects a new L-AMF corresponding to the target NG-RAN node and creates a L-AMF-C-AMF relationship for a UE when the L-AMF deals with a new NG Application Protocol (NGAP) association.

When performing inter AMF mobility operations, the C-AMF is responsible of the N14interface with the remote AMF. The split between C-AMF and L-AMF is hidden from the remote AMF(s).

By using a L-AMF and a local i-SMF, latency of mobility and session management is improved for a given PDU session served by L-AMF. The User plane also sees an improvement in latency of mobility and session management is improved for a given PDU session served by L-AMF.

In further examples, a Location Management Function (LMF) may be collocated with the L-AMF. Since an LMF typically has a lot of interaction with RAN, a local LMF will provide large benefits from latency point of view. LMF local to the RAN and L-AMF will help in computing location based on measurements of UE and RAN. The interactions can be more efficiently performed between local LMF and L-AMF.

Examples may be used for disaggregated cloud gNBs (as well as classical gNBs, although these will have more frequent L-AMF relocation).

Examples provide dual or multiple AMF connections for a single UE which can be slice/service based, e.g., based on slice(s), slice group(s), and/or slice/service type(s). A Hierarchy of AMFs and the associated interactions between a C-AMF and L-AMF are provided. Coordination is provided between AMFs for security handling, and a L-AMF may be selected based on service and/or slice characteristics, e.g., based on slice(s), slice group(s), and/or slice/service type(s).

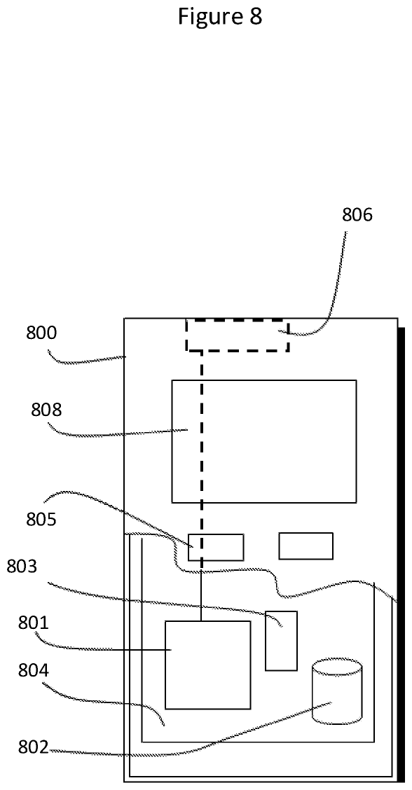

A possible wireless communication device will now be described in more detail with reference to FIG. 8 showing a schematic, partially sectioned view of a communication device 800. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts, and other information.

A wireless communication device may be for example a mobile device, that is, a device not fixed to a particular location, or it may be a stationary device. The wireless device may need human interaction for communication or may not need human interaction for communication. In the present teachings the terms UE or “user” are used to refer to any type of wireless communication device.

The wireless device 800 may receive signals over an air or radio interface 307 via appropriate apparatus for receiving and may transmit signals via appropriate apparatus for transmitting radio signals. In FIG. 8 transceiver apparatus is designated schematically by block 806. The transceiver apparatus 806 may be provided for example by means of a radio part and associated antenna arrangement. The antenna arrangement may be arranged internally or externally to the wireless device.

A wireless device is typically provided with at least one data processing entity 801, at least one memory 802 and other possible components 803 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 804. The user may control the operation of the wireless device by means of a suitable user interface such as key pad 805, voice commands, touch sensitive screen or pad, combinations thereof or the like.

A display 808, a speaker and a microphone can be also provided. Furthermore, a wireless communication device may comprise appropriate connectors (either wired or wireless) to other devices and/or for connecting external accessories, for example hands-free equipment, thereto. The communication devices 802, 804, 805 may access the communication system based on various access techniques.

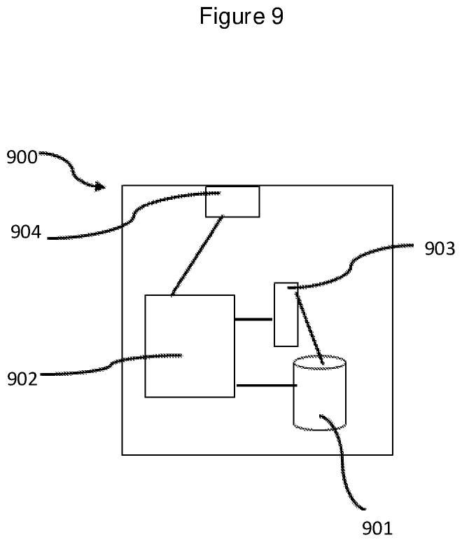

FIG. 9 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, an IAB or relay node, an AMF, a L-AMF, a C-AMF, an SMF or an i-SMF. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 900 can be arranged to provide control on communications in the service area of the system. The control apparatus 900 comprises at least one memory 901, at least one data processing unit 902, 903 and an input/output interface 904. Via the interface the control apparatus can be coupled to a receiver and a transmitter of the base station. The receiver and/or the transmitter may be implemented as a radio front end or a remote radio head. For example, the control apparatus 900 or processor 901 can be configured to execute an appropriate software code to provide the control functions.

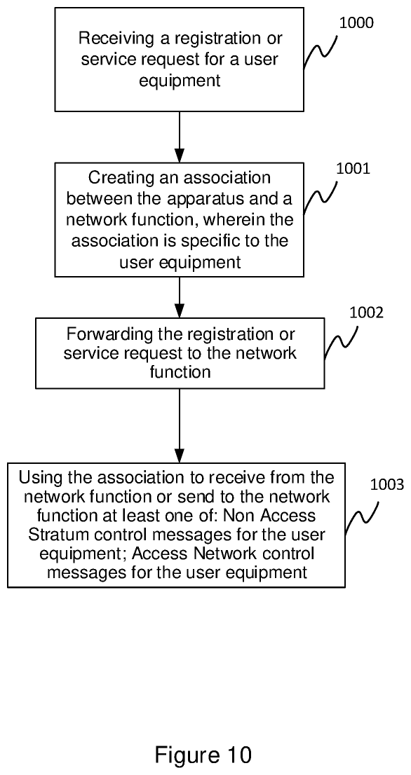

FIG. 10 is a flow chart of a method according to an example. The flow chart of FIG. 10 is viewed from the perspective of an apparatus such as L-AMF 554, 654 or 754.

At 1000, a registration or service request for a user equipment is received.

At 1001, an association between the apparatus and a network function is created. The network function may comprise a C-AMF such as C-AMF 556, 656 or 756 for example. The association may, in some examples, comprise a communication interface. The association may be specific to the user equipment.

At 1002, the registration or service request is forwarded to the network function.

The 1003, the apparatus uses the association to receive from the network function or send to the network function at least one of: Non Access Stratum control messages for the user equipment; Access Network control messages for the user equipment.

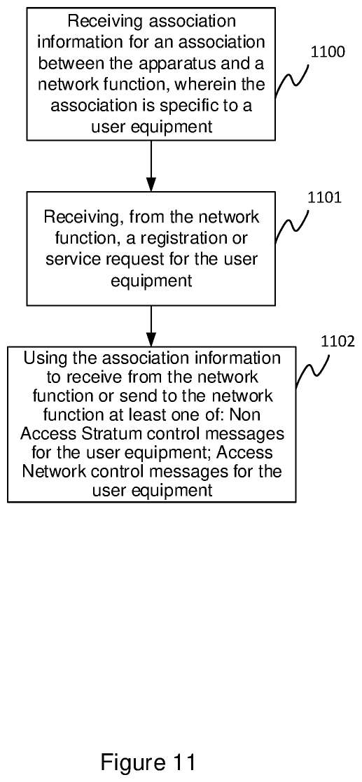

FIG. 11 is a flow chart of a method according to an example. The flow chart of FIG. 11 is viewed from the perspective of an apparatus such as C-AMF 556, 656 or 756.

At 1100, association information for an association between the apparatus and a network function is received. The network function may comprise a C-AMF 554, 654 or 754 for example. The association may, in some examples, comprise a communication interface. The association may be specific to the user equipment.

At 1101, a registration or service request for the user equipment is received from the network function.

At 1102, the method comprises using the association information to receive from the network function or send to the network function at least one of: Non Access Stratum control messages for the user equipment; Access Network control messages for the user equipment.

It will be understood that the described steps of the methods above are not necessarily purely sequential, according to some examples. This includes at least FIGS. 5 to 11.

In general, the various embodiments may be implemented in hardware or special purpose circuits, software, logic, or any combination thereof. Some aspects of the invention may be implemented in hardware, while other aspects may be implemented in firmware or software which may be executed by a controller, microprocessor, or other computing device, although the invention is not limited thereto. While various aspects of the invention may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices. magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1-27. (canceled)

28. An apparatus comprising:
at least one processor; and
at least one memory storing instructions which, when executed by the at least one processor, cause the apparatus to perform operations, the operations comprising at least:
receiving a request from a user equipment, wherein the request comprises a registration request for registering the user equipment with a network or a request for a service provided by the network;
creating an association between the apparatus and a network function of the network, wherein the association is specific to the user equipment;
forwarding the request to the network function; and
using the association to receive from the network function or send to the network function at least one of the following: Non Access Stratum control messages for the user equipment; or Access Network control messages for the user equipment.

29. The apparatus according to claim 28, wherein the creating the association comprises:
establishing an interface for communication between the apparatus and the network function for the at least one of the following: the Non Access Stratum control messages for the user equipment; or the Access Network control messages for the user equipment.

30. The apparatus according to claim 28, wherein the operations further comprise:
generating association information corresponding to the association; and
forwarding the association information to the network function.

31. The apparatus according to claim 28, wherein the apparatus is deployed in a radio access network node of the network.

32. The apparatus according to claim 28, wherein the apparatus implements at least one of the following: an intermediate SMF; or a gNB-Central Unit Control Plane.

33. The apparatus according to claim 28, wherein the operations further comprise:
releasing the association between the apparatus and the network function that is specific to the user equipment upon sending a release request or upon receiving a release request from the network function.

34. The apparatus according to claim 28, wherein the request comprises: a Globally Unique Temporary Identifier; or a Subscription Concealed Identifier, and wherein the operations further comprise:
receiving a registration acceptance message and in response:
assigning a Globally Unique Temporary Identifier to the user equipment.

35. The apparatus according to claim 28, wherein the operations further comprise:
forwarding at least one of N1 signalling or N2 signalling received from the user equipment to the network function;
receiving the at least one of N1 signalling or N2 signalling from the network function; and
forwarding the at least one of N1 signalling or N2 signalling to the user equipment.

36. The apparatus according to claim 28, wherein the operations further comprise:
subscribing to the network function for information of changes to security material for the user equipment;
receiving, from the network function, the security material for the user equipment;
using the security material to terminate Non Access Stratum signalling at the apparatus.

37. The apparatus according to claim 28, wherein the operations further comprise:
receiving, from the network function, a request to handle a Protocol Data Unit, PDU, session for the user equipment, the request comprising at least one of a PDU session identifier, a network slice identifier, a network slice group identifier, a Non Access Stratum Request from the user equipment or identification of a Session Management Function selected for the PDU session by the network function;
in response to the request to handle the PDU session for the user equipment, managing the PDU session for the user equipment.

38. The apparatus according to claim 37, wherein the managing the PDU session for the user equipment includes at least one of: handling of NAS exchanges with the user equipment about the PDU Session, handling the User plane activation and deactivation for the PDU Session; or handling mobility aspects of the PDU session.

39. An apparatus comprising:
at least one processor; and
at least one memory storing instructions which, when executed by the at least one processor, cause the apparatus to perform operations, the operations comprising at least:
receiving association information for an association between the apparatus and a network function of a network, wherein the association is specific to a user equipment;
receiving, from the network function, a request from the user equipment, wherein the request comprises a registration request for registering the user equipment with the network or request for a service provided by the network; and
using the association information to receive from the network function or send to the network function at least one of the following: Non Access Stratum control messages for the user equipment; or Access Network control messages for the user equipment.

40. The apparatus according to claim 39, wherein the association is created by the network function establishing an interface for communication between the apparatus and the network function for the at least one of the following: the Non Access Stratum control messages for the user equipment; or the Access Network control messages for the user equipment.

41. The apparatus according to any of claim 39, wherein the operations further comprise:
releasing the association information for the association that is specific to the user equipment between the apparatus and the network function upon triggering a release request from the apparatus or upon receiving a release request from the network function.

42. The apparatus according to claim 39, wherein the operations further comprise:
prior to using the association information to receive from the network function or send to the network function the at least one of the following: the Non Access Stratum control messages for the user equipment; or the Access Network control messages for the user equipment: ensuring the apparatus has a proper security context for the user equipment.

43. The apparatus according to claim 39, wherein the operations further comprise:
receiving at least one of N1 signalling or N2 signalling from the network function;
sending the at least one of the N1 signalling or the N2 signalling to the user equipment via the network function.

44. The apparatus according to claim 39, wherein the operations further comprise:
receiving, from the network function, a subscription request for subscribing to receive information regarding changes to security material for the user equipment;
sending, to the network function, the security material for the user equipment.

45. The apparatus according to claim 39, wherein the operations further comprise:
sending, to a Session Management Function, a request to handle a PDU session for the user equipment, the request comprising at least one of the following: a PDU session identifier, a network slice identifier, a network slice group identifier; or a Non Access Stratum Request from the user equipment;
sending, to the network function, a request for the network function to interface the Session Management Function for the PDU Session.

46. The apparatus according to claim 39, wherein the operations further comprise:
sending, to the network function, a request to manage a PDU session for the user equipment, the request to manage the PDU session for the user equipment comprising a PDU session identifier, a network slice identifier, a network slice group identifier; a Non Access Stratum Request from the user equipment and identification of a Session Management Function selected for the PDU session and an implicit indication for the network function to select an intermediate Session Management Function for handling the PDU session,
wherein the apparatus implements the intermediate Session Management function.

47. The apparatus according to claim 39, wherein the operations further comprise:
receiving a further request related to mobility of the user equipment;
selecting a new network function for a target radio access node for the user equipment;
creating an association between the apparatus and the new network function for the user equipment;
forwarding the mobility request to the new network function;
using the association to receive from the new network function or send to the new network function the at least one of the following: the Non Access Stratum control messages for the user equipment; or the Access Network control messages for the user equipment.
